(19) United States
(12) Patent Application Publication
(10) Pub. No.: US 2013/0005616 A1
(43) Pub. Date: Jan. 3, 2013

(54) ENHANCED OIL RECOVERY PROCESS USING WATER SOLUBLE POLYMERS HAVING IMPROVED SHEAR RESISTANCE

(75) Inventors: Nicolas Gaillard, Saint Etienne (FR); Cédrick Favero, Saint Romain Le Puy (FR)

(73) Assignee: SPCM S.A., Andrezieux Boutheon (FR)

(21) Appl. No.: 13/581,527

(22) PCT Filed: Mar. 15, 2010
(86) PCT No.: PCT/EP2010/053276

§ 371 Date: Aug. 28, 2012

(51) Int. Cl. C09K 8/588

(52) U.S. Cl. 507/225

(57) ABSTRACT

An enhanced oil recovery process using high molecular weight water soluble polymer consisting in: —dispersing said polymer in injection brine, —and then injecting the dispersed polymer in the subterranean formation, characterized in that the high molecular weight water soluble polymer contains at least a non-ionic monomer and at least an amphiphilic monomer containing at least a side chain having an HLB above 4.5, said high molecular weight water soluble polymer having a molecular weight of more than 10 000 000.

The present invention relates to an enhanced oil recovery process using water soluble polymer having improved shear resistance. The invention comprises the use of a water soluble polymer containing pendant hydrophobic group, which is dispersed in injection brine, and then injected in the subterranean formation. The water soluble polymer is able to resist to mechanical stress and so the degradation of the polymer is limited. The polymer is able to uncoil and develop viscosity after entering the formation resulting in higher viscosity in the formation and an improved sweep efficiency.

In crude oil extraction, water can be injected into the stratum to drive the crude oil out of the ground. The oil cut decreases after water flooding due to channeling. It is well known by the man of the art that in order to increase the efficiency of water flood, mobility ratio (the ratio of the mobility of the water to that of the oil in a petroleum reservoir) has to be decreased to mobilize more oil.

This can be achieved by increasing water viscosity in the reservoir using hydrosoluble polymers. Hydrosoluble polymer are solubilized on surface and then injected in the reservoir giving higher viscosity to water.

Polymers commonly used are high molecular weight anionic polyacrylamides. However, before performing a polymer injection, many parameters have to be taken into account to get the targeted viscosity of polymer solution in the reservoir. Mobility control and sweep efficiency are achieved only if viscosity is maintained during polymer propagation. However, polymers are chemicals that can experience chemical, thermal and mechanical degradations.

Thermal degradation of polyacrylamide is related to hydrolysis of acrylamide moieties. New anionic charges are generated on the backbone chain of the polymer. In the presence of divalent ions (Calcium, Magnesium), the viscosity of the solution containing the polymer will drop due to bridging effect of Ca, Mg with anionic charges of the polymer, and partial precipitation. The hydrolysis of polyacrylamide increases with temperature. Usually, very low hydrolysis is observed at low temperatures. Polyacrylamides can be modified with functional monomers such as N-vinyl pyrrolidone or 2-acrylamido-2-methylpropane sulphonic acid to provide tolerance to brines containing divalent ions and protection to hydrolysis, thanks to a neighboring effect.

Radical degradation is related to the generation of radicals that can react with polyacrylamide backbone chains resulting in a drop of molecular weight and a drop of viscosity of the solution due to a reduction of the hydrodynamic volume. These radicals can be generated by heat through the cleavage of weak links in polymer chain, some residue of catalyst or from impurities from others chemicals. Red/ox systems are also involved in the generation of free radicals. Free radicals can be generated by the presence of oxygen, impurities from water, polymer or other chemicals. The presence of iron II or/and H₂S is known to induce an acceleration of radical formation in the presence of oxygen (red/ox system). Polyacrylamide can be designed and formulated to minimize the formation of free radicals or their effect on polymer backbone. Water quality can be adjusted to prevent redox system and protective package added.

Mechanical degradation can only be minimized by a change in equipment design or by reducing the molecular weight of the injected polymer, but can't be avoided. It occurs during processes of mixing, transfers of the polymer solution through pumps and valves and injection of the polymer solution through perforations at well bore. This is dependent of the injection equipment design. Unfortunately, polyacrylamide are sensitive to shear degradation due to their high molecular weight and their high level of entanglement. The viscosity loss of polymer solution can be up to 10%-50%.

As mentioned above, a solution to limit these degradations is to use low molecular weight polymers that are less sensitive to shear degradation than high molecular weight polymers. However, a higher quantity of low Mw polymer is required to achieve targeted viscosity leading to economical limitation.

Another solution is the use of associative polymers. These polymers contain hydrophobics moieties that are able to associate and dissociate in water depending on the shear stress applied. Thus when low shear stress is applied, associations through hydrophobic physical bound occur resulting in an increase of the viscosity of the aqueous solution. When a high shear stress is applied, hydrophobic linkages dissociate resulting in a viscosity drop of the solution as associated polymers are made of low molecular weight polymers. Thus considering a water injection containing associative polymers, viscosity of the solution is low during injection step due to high shear stress and when the solution of the polymer enters the reservoir, shear stress decreases and viscosity increases due to hydrophobic associations. These polymers could be very good candidates as brine viscosifiers for EOR but they show limitations.

A light level of association translates in an exponential increase of the viscosity when the concentration of the polymer is increased compared to a non associative polymer. Due to this behavior, if during the propagation in the reservoir the concentration of polymer in the solution decreases by dilution from water entering in the reservoir or by adsorption, the viscosity of the polymer solution will become impredictably low.

It's well documented that the incorporation of the hydrophobic group increases the adsorption of such polymer. They adsorb a lot in porous media resulting in drastic loss of viscosity and risk of altering the permeability and the injectivity of the reservoir. It's also known that the strength of the association and thus the viscosity of the polymer solution decreases with the temperature making the associative polymer poorly efficient when the temperature exceeds 60° C.

U.S. Pat. No. 4,694,046 discloses an hydrophobic associative polymer having a form of a terpolymer of acrylamide, an alkali metal or ammonium salt of acrylic acid and an hydrophobic alkyl acrylamide monomer. Hydrophobic alkyl group of acrylamide is mentioned as being a C6-C22 chain. Typical alkyl which is illustrated is octyl. The molecular weight of the polymer has an upper limit of 10 M. The hydrophobic monomers are pure hydrophobic.

The combination of a low molecular weight with the use of an associative polymer permits to decrease the mechanical degradation of the polymer. Nevertheless, the process continues to require a high amount of polymer as explained above.

WO2005/100423 discloses a high molecular weight associative polymer comprising at least one cationic monomer derived from acrylamide bearing at least one hydrophobic chain of 8 to 30 carbon atoms. The drawbacks of using such polymer are typical of the so called associative polymer, i.e. high sensitivity to dilution (viscosity drop), high level of adsorption and poor viscosity during propagation when temperature is under 60° C.

A device exists (WO/107492 PSU) and a method for dispersing a water-soluble polymer in powder forms is provided. But it cannot avoid degradation during the injection of the polymer solution through perforations into entire formation close to well bore.

In the description, the following expressions have to be understood as meaning:

Swellable polymer: polymer that is able to expand, in aqueous media, due to hydration of the three dimensional network. The network is constituted by covalent bridges obtained by inclusion of crosslinker in a sufficient amount to bridge all the linear chains together. For example, EP 1290310 describes the injection of particles that are swelling with temperature in the reservoir but remains under insoluble spherical shape. The goal of this patent is to modify the permeability of subterranean formation (conformance control).

Uncoiled polymer: polymer that has been allowed to untwist, in aqueous media, due to dissociation of physical links, such as Hydrogen bond, ionic and hydrophobic interactions. The dissociation is related to the speed of hydration and to the solvatation power of the solvent and the ionic repulsive forces to counter-balance the attractive physical forces. Said solvents being water or salted water.

Hydrophobic associative polymer: it is meant water soluble polymers that contain hydrophobic moieties that are able to associate in aqueous media. The associations through hydrophobic interactions in water generate a viscoelastic structure in solution resulting in a high increase of the viscosity thanks to a supramolecular structure. When a shear stress is applied, associations are disrupted resulting in drastic viscosity drop as the viscosity as created only by low molecular weight individual polymer chains.

The goal of the invention is to overcome the deficiencies of water soluble polymers used in the prior art for thickening aqueous fluids when it may experience a high level of shear. It is therefore the goal of the invention to provide an Enhanced Oil Recovery process using a high molecular weight water soluble polymer unsensitive to shear degradation which improves sweep efficiency. The use of a high molecular weight water soluble polymer would also permit to decrease the required amount of polymer and then the cost of the process.

It has been surprisingly found that the incorporation, in a high molecular weight polymer produced with a dispersed polymerization process (Cf Radical polymerization in dispersion systems—J. Barton, I. Capek—Ellis Horwood series a polymer chemistry), of an amphiphilic monomer having side group with a HLB above 4.5 permits to delay the uncoiling of the polymer particles during its injection in subterranean formation. Thus, during injection step, polymer chains are coiled and can resist to shear stress. After some time (few hours to days preferably) in the reservoir, polymer uncoils and viscosity increases thanks to the hydrodynamic volume of the preserved high molecular weight polymer chain without showing an associative behaviour.

In other words, the ultimate viscosity of the polymer is obtained in the reservoir ensuring a better sweep efficiency and higher oil recovery factor.

As a consequence, the invention concerns an enhanced oil recovery process using a high molecular weight water soluble polymer consisting in:
dispersing said polymer in injection brine,
and then injecting the dispersed polymer in the subterranean formation.

The process is characterized in that the polymer contains at least a non-ionic monomer and at least an amphiphilic monomer containing at least a side chain having an HLB above 4.5 and in that it has a molecular weight of more than 10 000 000.

HLB: Hydrophilic-Lipophilic Balance of a chemical compound is a measure of the degree to which it is hydrophilic or lipophilic, determined by calculating values for the different regions of the molecule, as described by Griffin in 1949.

In the present invention we adopted the method of Griffin based on calculating a value based on the chemical groups of the molecule. Griffin assigned a dimensionless number between 0 and 20 to give information on water and oil solubility. Substances with an HLB value of 10 are distributed between the two phases so that the hydrophilic group (Molecular mass Mh) projects completely into the water while the hydrophobic hydrocarbon group (Molecular mass Mp) is adsorbed in the nonaqueous phase.

The HLB value of a substance with a total molecular mass M and a hydrophilic portion of a molecular mass Mh is given by:

HLB=20 (Mh/M)

The amount of amphiphilic monomer is adjusted to minimize the associative character of the polymer after uncoiling but need to be high enough to delay the uncoiling so as it happens after reaching the low shear propagation area of the reservoir. Typically the percentage in weight of the amphiphilic monomer regarding the weight of the high molecular weight water soluble polymer must be less than 10% preferably between 0.1% and 7%, more preferably between 0.2% and 5%.

According to the invention, the polymer used includes all types of ionic synthetic polymers soluble in water, including amphoteric (co)polymers.

Practically, the polymer used consists of:
a) at least one non-ionic monomer selected from the group comprising (meth)acrylamide, (meth)acrylic, vinyl, allyl or maleic backbone and having a polar non-ionic side group: mention can be made in particular, and without this being limitation, of acrylamide, methacrylamide, N-vinyl pyrrolidone, N-vinyl formamide, N,N dimethylacrylamide, N-vinyl acetamide, N-vinylpyridine, N-vinylimidazole, isopropyl acrylamide and polyethelene glycol methacrylate
b) at least one amphiphilic monomer. These monomers are selected from the group comprising (meth)acrylamide, (meth)acrylic, vinyl, allyl or maleic backbone, having a side group selected from the group of alkyl, arylalkyl containing at least one heteroatom. The side group is characterized by having an amphiphilic character corresponding to an Hydrophilic Lipophilic Balance (HLB) above 4.5. Mention can be made in particular, and without this being limitation, of acrylamido undecanoic acid, acrylamido methyl undodecyl sulphonic acid, dimethyl dodecyl propyl methacrylamide ammonium chloride, derivatives of acrylic acids such as alkyl acrylates or methacrylates for example behenyl 25-ethoxylated methacrylate. Also useable are derivative of vinyl monomers such as alkyl vinyl amine or alkylvinyl amide
   optionally combined with
c) one or more anionic monomer(s) selected from the group comprising, (meth)acrylic, vinyl, allyl or maleic backbone mention can be made in particular, and without this being limitation, of monomers having a carboxylic function (e.g.: acrylic acid, methacrylic acid and salts thereof), or having a sulphonic acid function (e.g.: 2-acrylamido-2-methylpropane sulphonic acid (ATBS) and salts thereof).
d) one or more cationic monomer(s) selected from the group comprising an (meth)acrylamide, (meth)acrylic, vinyl, allyl or maleic backbone and having an amine or quaternary ammonium function, mention can be made in particular, and without this being limitation, of dimethylaminoethyl acrylate (ADAME) and/or dimethylaminoethyl methacrylate (MADAME), quaternized or salified, dimethyldiallylammonium chloride (DADMAC), acrylamido propyltrimethyl ammonium chloride (APTAC) and/or methacrylamido propyltrimethyl ammonium chloride (MAPTAC),
e) one or more branching agent(s) selected from the group comprising methylene bisacrylamide (MBA), ethylene glycol diacrylate, polyethylene glycol dimethacrylate, diacrylamide, cyanomethylacrylate, vinyloxyethylacrylate or methacrylate, triallylamine, formaldehyde, glyoxal, compounds of the glycidylether type such as ethyleneglycol diglycidylether, or epoxy. The amount of branching agent is lower than 50 ppm to keep the polymer fully water soluble

According to the invention, the water-soluble polymer has a molecular weight more than 10.000.000, preferably from 11.000.000 to 35.000.000. These high molecular weight polymers are more effective to thicken brines in the reservoir. This high level of molecular weight is maintained during injection. The typical degradation of high molecular weight polymer is prevented by keeping the molecule coiled thanks to the incorporation of specific monomers.

According to the invention the polymer is obtained by inverse emulsion or water in water polymerisation which allows to easily obtain very high molecular weight polymers. Therefore, the polymer has a liquid form and not a solid form.

Due to the selection of monomers, the polymer may have a linear, branched structure or a comb architecture (comb polymer) or a star structure (star polymer) but must be fully water soluble.

The EOR process is characterized by a continuous injection of the solution of polymer to propagate through all the reservoir and be produced back with the oil. In particular the solution of polymer is injected over period longer than one month and over quantities higher than 0.1 pore volume.

The polymer in the reservoir doesn't show a pronounced associative behavior after several days or weeks thanks to a careful selection of the hydrophobic side chain and the possibility of hydrolysis of this side chain from the hydrophilic polymer.

According to the invention, the typical dosage of polymer in the developed EOR process range from 200 ppm to 7500 ppm in extreme conditions.

The process of the invention and the described polymer can also be used for water shut off and conformance control, when a high shear zone is expected. However this is not a goal of the present invention to use the described polymer for these applications as the formation of a viscous enough slug requires high concentration of polymer making the process not particularly advantageous.

An additional possible use of the described polymer is as a drag reducer, for instance hydraulic fracturing, where injection of polymer in water in oil emulsion form is common. The delayed uncoiling can reduce degradation in the early stage of the injection and bring some benefits.

The invention will now be fully illustrated using the following, non limiting examples, and notably which will not be considered as being limited to the compositions and forms of the polymers.

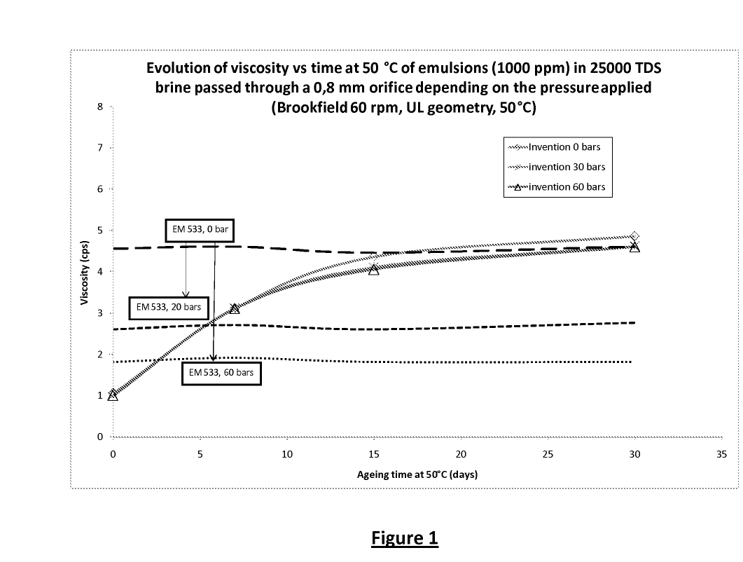

FIG. 1 is a diagram showing the evolution of the viscosity vs time of polymer of the invention

### EXAMPLE

### Synthesis of Polymer

### Synthesis of 30% Mol Anionic Inverse Emulsion

### Process 1: Water in Oil Emulsion

A non aqueous continuous phase was prepared comprising 132 g of low odor paraffin oil, 15 g of sorbitan monooleate and 2 g of a polymeric surfactant (Hypermer 2296, Croda). An aqueous monomer solution comprising 184 g of a 50% acrylamide solution, 40.1 g of acrylic acid and 59 g of deionized water was neutralized with 44.5 g of caustic 50%. Sodium formiate was added as transfer agent to limit molecular weight (Mw) of the final polymer to 22 million g/mol. To this solution was added 0.45 g of a 50 g/l potassium bromate solution and 0.6 g of a 200 g/l diethylenetriaminepentaacetate pentasodique solution. The pH was adjusted to 6.8.

The resulting oil and aqueous solution were combined and homogenized to yield uniform water in oil emulsion. After deoxygenation with nitrogen for 30 minutes, polymerization is initiated by addition of sodium bisulfite solution via a syringe pump. The reaction temperature is allowed to increase to about 55° C. in about 1 hour 30 minutes. The reaction mixture is then treated with excess of ter-butyl hydroperoxide and bisulfite solution to reduce free monomers.

The resulting product is a stable and gel free emulsion having interesting characteristics for oil applications.

The same procedure is used wherein a desired amount of the amphiphilic monomer is incorporated in the aqueous monomer solution to make the various samples evaluated in table 1.

The resulting product is a stable and gel free emulsion having interesting characteristics for oil applications.

### Process 2: Water in Water Emulsion

Glycerol (10.5 g), ammonium sulfate (56 g) and self made polymer surfactant 12% (105 g) were added to water (207 g) in a 3 neck round bottom flask. Sodium hypophosphite is added to limit molecular weight (Mw) of final polymer to 22 million g/mol. Solution was stirred using a mechanical stirrer and acrylamide 50% (195 g), acrylic acid (42.4 g), polyethoxylated behenyl methacrylate (PEBMA) (HLB=15.6) solution 50% (6 g) were added. The pH was adjusted to 3.4 using sodium hydroxide 50%. The reactive media was stirred until all components were solubilized. It was then sparged with N2 during 30 minutes, temperature was raised to 30° C. Complexing agent and sodium bromate were then added and polymerization was initiated by addition of sodium dithionite solution via a syringe pump. The reaction temperature kept between 30 and 32° C. during 7 hrs.

The reaction mixture is then treated with excess of ter-butyl hydroperoxide and bisulfite solution to reduce free monomers. The resulting product is a stable and gel free water in water emulsion.

### Results

### Filter Ratio (FR) Measurement

For the determination of the filtration ratio of the sheared Flopaam 3130S solution a 5 micron Millipore Isopore filter with a diameter of 47 mm. The filtration procedure is as follows:
1. Insert the filter into the bottom part of the Sartorius SM16249 filtration set-up or equivalent set-up.
2. Pour 400 ml of the prepared polymer solution into the upside down top part of the filtration set-up and insert the bottom part into the top part. Subsequently turn the full set-up 180 degrees and connect to the nitrogen line.
3. Set the nitrogen pressure at 30 psi (˜2 bar) and measure the filtrate volume as a function of time. Stop the filtration process when a filtrate volume of 300 ml has been collected.
4. Calculate the filtration ratio with:

FR=(t_{300 ml}−t_{200 ml})/(t_{200 ml}−t_{100 ml})

The sheared polymer solution passes the test when the value for the FR<1.5.

In order to assess the properties of the invention compared to already existing technologies, tests were performed and results were compared to products from prior art (see table 1).

Patents EP 1 290 310 (Nalco) (entry 6 table 1) describing polymer particle that can swell during propagation in the reservoirs and U.S. Pat. No. 4,694,046 (Exxon) (entry 5 table 1) describing associative polymers obtained by micellar polymerization under a powder form.

For all examples, polymer concentration is 1000 ppm. Brine is 2.5% NaCl, 0.1% Na₂CO₃. Initial viscosity variation corresponds to viscosity measured just after shearing. Shear rate applied is 250 000 s⁻¹ using method described previously. Value equal to 0% indicates good shear resistance.

Viscosity variation after 5 and 60 days ageing are related to initial viscosity before shear stress. Filter Ratio (FR) is measured to assess good filterability of the polymer. FR<1.5 is required to ensure a good propagation of the polymer in the reservoir.

DMAPMA BrCl2 is N-methacrylamidopropyl-N,N-dimethyl-N-dodecylammonium bromide.

PEBMA is polyethoxylated behenyl methacrylate

TABLE 1
Shear resistance and viscosity enhancement of different polymers in field conditions (50° C.)

| | | Mol %/ | | % Viscosity variation | | | |
|---|---|---|---|---|---|---|---|
| | amphiphilic | Weight % of | | | After 5 | After 60 | |
| | monomer | amphiphilic | Process nber/ | | days at | days at | FR after |
| Entry | (HLB) | monomer | Product form | initial | 50° C. | 50° C. | 60 days |
| 1 | none | 0% | 1/Inverse | −40% | −40% | −40% | 1.04 |
| | | | Emulsion | | | | |
| 2 | PEBMA | 0.2%/4% | 1/Inverse | 0% | +250% | +450% | 1.45 |
| | (15.6) | | emulsion | | | | |
| 3 | PEBMA | 0.1%/2% | 2/Water in | 0% | +100% | +175% | 1.27 |
| | (15.6) | | water emulsion | | | | |
| 4 | DMAPMA | 0.1%/0.059% | 1/Inverse | 0% | +15% | +70% | 1.34 |
| | BrC12 (9.9) | | emulsion | | | | |
| 5 | Tert- | 1%/0.026% | powder | −60% | −60% | −60% | 1.05 |
| | octylacrylamide | | | | | | |
| | (0) | | | | | | |
| 6 | none | 0% | 1/Inverse | 0% | +1% | +500% | Filter |
| | | | emulsion | | | | plugged |

Entry 1 corresponds to a comparative example with no functionalized monomer. This product shows bad resistance to shear. Viscosity drops as soon as high shear stress is applied. Then low viscosity obtained remains constant with time.

Polymer from the invention (entries 2, 3 and 4) show very good shear resistance properties (0% viscosity loss) and develop viscosity with time (up to 500%) with good filterability (FR<1.5).

Polymers from prior art (entry 5) show bad shear resistance. Usually, this type of polymers is known to be able to recover its viscosity with time when a shear stress is applied. However, this capability of recovering viscosity is only observed for shear stresses below 20 000 s⁻¹. Above 20 000 s⁻¹, polymer chains are cut resulting in viscosity drop. This is observed for polymer in entry 5. Remaining viscosity after shearing is very low and cannot ensure a good sweep efficiency in the reservoir.

Polymer of US2003/0155122 (Nalco) (entry 6) shows similar behavior than the polymer of the invention regarding shear resistance and viscosity variation with time. However, this kind of polymer does not uncoil with time, it swells keeping a particle shape. Filtration of such polymer is not possible when swelled. The ultimate goal of such a polymer is to plug an area for conformance purpose. It will plug a high permeability area in the reservoir so that further water injections are deviated to lower permeability zones. It cannot ensure sweep efficiency once time swelled.

### Example 2

The purpose of this example is to compare standard Inverse Emulsion (broken line) to Inverse Emulsion of the invention (continuous line) regarding the evolution of the viscosity versus time at 50° C. in a brine. The viscosity increase is directly connected to the sweep efficiency and so to the oil recovery factor.

According to FIG. 1, it can be seen that shear, occurs by an injection pressure of 20 bars or 60 bars, is really detrimental to the standard 30% mol anionic Inverse Emulsion (Entry 1 of table 1), leading to viscosity drop from 4.5 cps (0 bars), to 2.7 cps (20 bars) to 1.9 cps for a pressure of 60 bars.

The emulsion of the present invention has an initial viscosity of 1 cps in the brine. This viscosity increases with time up to 4.8 cps after 30 days, reaching the same viscosity of unsheared 30% mol anionic Inverse Emulsion. When shear is applied to this solution, the viscosity profile versus time is exactly the same than the one that has not be sheared.

The final viscosity of sheared solutions stressed at 60 bars reaches 4.5 cps after 30 days instead of the 1.9 cps obtained with standard 30% mol anionic Inverse Emulsion. Thus the gain of viscosity using the emulsion of the present invention is 60% at 60 bars compared to the standard 30% mol anionic Inverse Emulsion.

The invention allows to increase the sweep efficiency and so the oil recovery factor.

1. An enhanced oil recovery process using high molecular weight water soluble polymer consisting in:
dispersing said polymer in injection brine,
and then injecting the dispersed polymer in the subterranean formation, characterized in that the high molecular weight water soluble polymer contains at least a non-ionic monomer and at least an amphiphilic monomer containing at least a side chain having an HLB above 4.5, said high molecular weight water soluble polymer having a molecular weight of more than 10 000 000.

2. An enhanced oil recovery process according to claim 1, characterized in that the amphiphilic monomer represents less that 10% by weight of the high molecular weight water soluble polymer, preferably between 0.1% and 7%, more preferably between 0.2% and 5%.

3. An enhanced oil recovery process according to claim 1, characterized in that the non-ionic monomer is selected from the group containing acrylamide, methacrylamide, N-vinyl pyrrolidone, N-vinyl formamide, N,N dimethylacrylamide, N-vinyl acetamide, N-vinylpyridine, N-vinylimidazole, isopropyl acrylamide and polyethelene glycol methacrylate.

4. An enhanced oil recovery process according to claim 1, characterized in that the amphiphilic monomer is selected from the group comprising (meth)acrylamide, (meth)acrylic, vinyl, allyl or maleic backbone, having a side group selected from the group of alkyl, arylalkyl containing at least one heteroatom.

5. An enhanced oil recovery process according to claim 1, characterized in that the amphiphilic monomer is selected from the group containing acrylamido undecanoic acid, acrylamido methyl undodecyl sulphonic acid, dimethyl dodecyl propyl methacrylamide ammonium chloride, behenyl 25-ethoxylated methacrylate.

6. An enhanced oil recovery process according to claim 1, characterized in that the high molecular weight water soluble polymer comprises at least one anionic monomer(s) selected from the group comprising, acrylic acid, methacrylic acid and salts thereof, 2-acrylamido-2-methylpropane sulphonic acid (ATBS) and salts thereof.

7. An enhanced oil recovery process according to claim 1, characterized in that the high molecular weight water soluble polymer has a molecular weight from 11.000.000 to 35.000.000.

8. An enhanced oil recovery process according to claim 1, characterized in that the high molecular weight water soluble polymer is obtained by inverse emulsion or water in water polymerisation.

9. An enhanced oil recovery process according to claim 1, wherein the high molecular weight water soluble polymer is injected at a rate of 200 to 7500 ppm.
